(19) United States
(12) Patent Application Publication
(10) Pub. No.: US 2024/0075854 A1
(43) Pub. Date: Mar. 7, 2024

(54) Child Carseat Mountable Electronic Device Mounting Device

(71) Applicant: Deonne Williams, Chicago, IL (US)

(72) Inventor: Deonne Williams, Chicago, IL (US)

(21) Appl. No.: 17/901,297

(22) Filed: Sep. 1, 2022

(51) Int. Cl. B60N 2/26

(52) U.S. Cl. CPC B60N 2/26

(57) ABSTRACT

A child carseat attachable mounting device for mounting a tablet computer to a child carseat includes a housing, which defines an interior space and which is selectively mountable to a bottom of a child carseat. Thus mounted, the housing is removably attached to the child carseat and is positioned between the child carseat and a seat of a vehicle upon fastening of the child carseat to the seat. An articulating arm is slidably attached to the housing and is selectively extensible through a slot that is positioned in a forward facet of the housing. A terminus of the articulating arm is selectively positionable in front of a child who is harnessed to the child carseat. A fastener, which is hingedly attached to the terminus of the articulating arm, selectively attaches to an electronic device so that its display is positioned to be viewed by the child.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to mounting devices and more particularly pertains to a new mounting device for mounting a tablet computer to a child carseat. The present invention discloses a mounting device that includes an articulating arm, which is selectively extensible from a housing mounted to a bottom of a child carseat. A fastener attached to the articulating arm allows for mounting of a tablet computer.

### (2) Description of Related Art Including Information Disclosed Under 37 CFR 1.97 and 1.98

The prior art relates to mounting devices, which may comprise mounting devices attachable to bars of child carseats and strollers with digital video display mounted to their hood. Related prior art includes child carseats with crossbars having integral displays, highchairs with means for attaching tablet computers to their trays, mounting devices for attaching tablet computers to strollers, and articulating arms for flexibly mounting electronic devices. What is lacking in the prior art is a mounting device comprising an articulating arm, which is selectively extensible from a housing mountable to a bottom of a child carseat. A fastener attached to the articulating arm allows for mounting of a tablet computer

### BRIEF SUMMARY OF THE INVENTION

An embodiment of the disclosure meets the needs presented above by generally comprising a housing, which defines an interior space and which is configured to be selectively mountable to a bottom of a child carseat. Thus mounted, the housing is removably attached to the child carseat and is positioned between the child carseat and a seat of a vehicle upon fastening of the child carseat to the seat.

An articulating arm is slidably attached to the housing and is selectively extensible through a slot that is positioned in a forward facet of the housing. A terminus of the articulating arm is selectively positionable in front of a child who is harnessed to the child carseat. A fastener is hingedly attached to the terminus of the articulating arm and is configured to selectively attach to an electronic device, such as a tablet computer, smartphone, or the like, so that a display of the electronic device is positioned to be viewed by the child.

Another embodiment of the disclosure includes a system comprising a child carseat, an electronic device, and a child carseat attachable mounting device. Furthermore, this system may comprise a pair of headphones, which is communicatively engaged to the electronic device, and a smartphone, upon which programming code is positioned enabling a user to utilize the smartphone for selecting content for viewing on the electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a child carseat attachable mounting device according to an embodiment of the disclosure.

FIG. 2 is a front view of an embodiment of the disclosure.

FIG. 3 is a side view of an embodiment of the disclosure.

FIG. 4 is a side extended view of an embodiment of the disclosure.

FIG. 5 is a side retracted view of an embodiment of the disclosure.

FIG. 6 is a top view of an embodiment of the disclosure.

FIG. 7 is an in-use view of an embodiment of the disclosure.

### DETAILED DESCRIPTION OF THE INVENTION

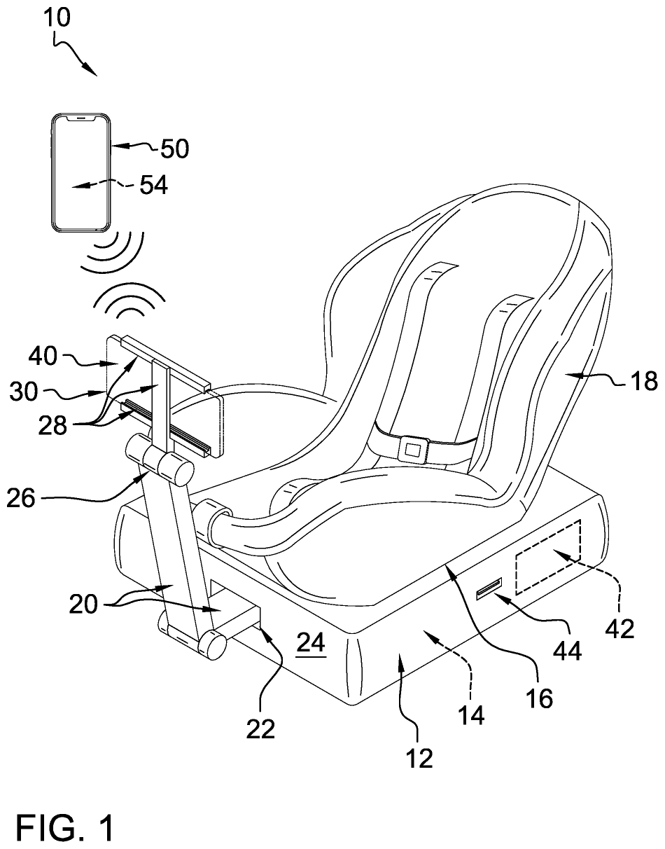

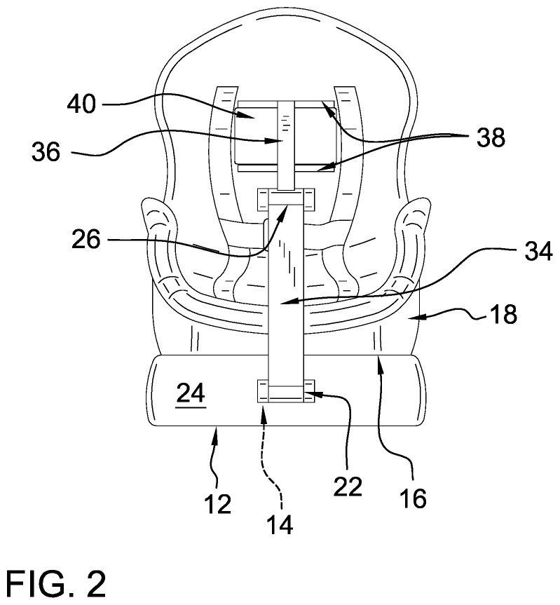

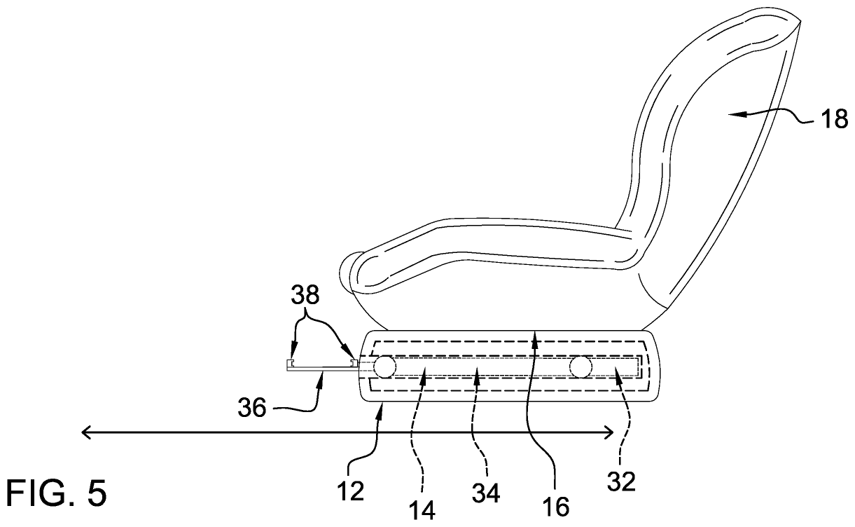

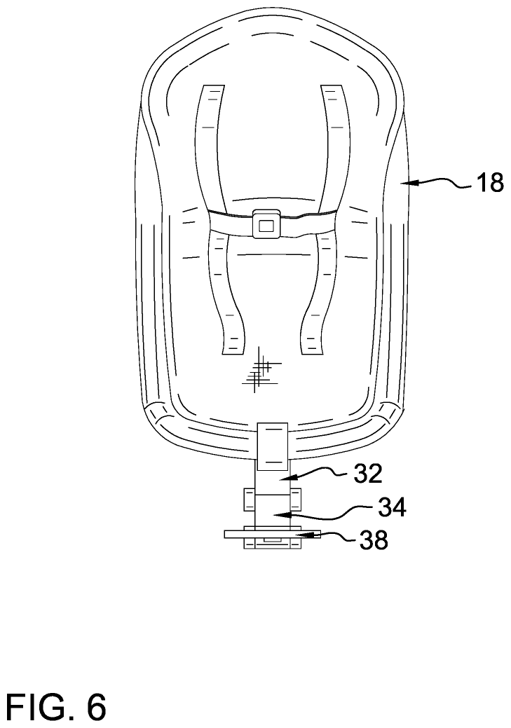

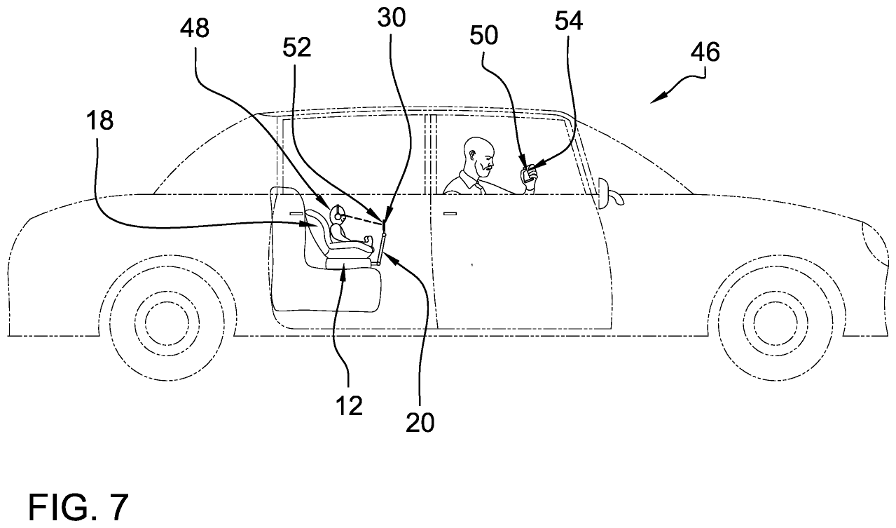

With reference now to the drawings, and in particular to FIGS. 1 through 7 thereof, a new mounting device embodying the principles and concepts of an embodiment of the disclosure and generally designated by the reference numeral 10 will be described.

As best illustrated in FIGS. 1 through 7, the child carseat attachable mounting device 10 generally comprises a housing 12, which defines an interior space 14 and which is configured to be selectively mountable to a bottom 16 of a child carseat 18. Thus mounted, the housing 12 is removably attached to the child carseat 18 and is positioned between the child carseat 18 and a seat of a vehicle upon fastening of the child carseat 18 to the seat. The housing 12 can be selectively removed from the child carseat 18 for attachment to a stroller. A variety of attachment methods for removably attaching the housing 12 to the bottom 16 of the child carseat 18 are known to those skilled in the art of removable mountings and are anticipated by the present invention. These attachment methods include latches, toggle bolts, and the like. The present invention also anticipates the housing 12 being integral to the child carseat 18.

An articulating arm 20 is slidably attached to the housing 12 and is selectively extensible through a slot 22 that is positioned in a forward facet 24 of the housing 12. A terminus 26 of the articulating arm 20 is selectively positionable in front of a child who is harnessed to the child carseat 18. A fastener 28 is hingedly attached to the terminus 26 of the articulating arm 20 and is configured to selectively attach to an electronic device 30, such as a tablet computer, smartphone, or the like, so that a display 52 of the electronic device 30 is positioned to be viewed by the child. In event of rapid deceleration, the articulating arm 20 allows the electronic device 30 to move forward, away from the child in the child carseat 18, to prevent injury to the child.

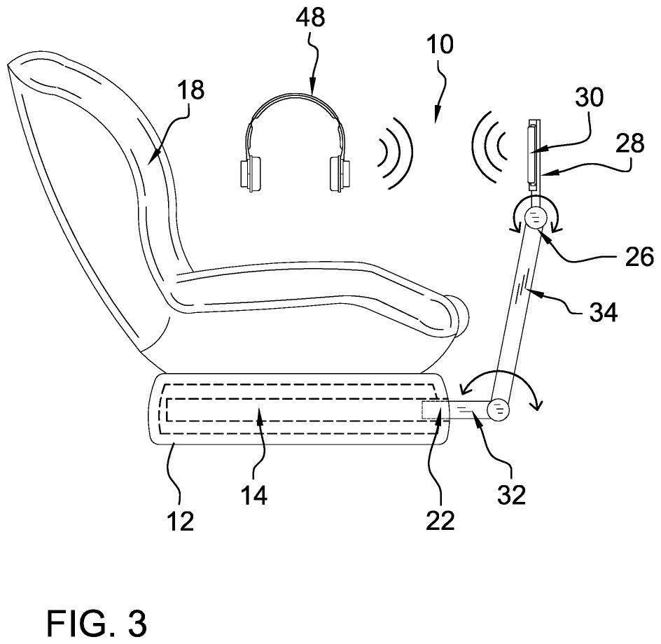

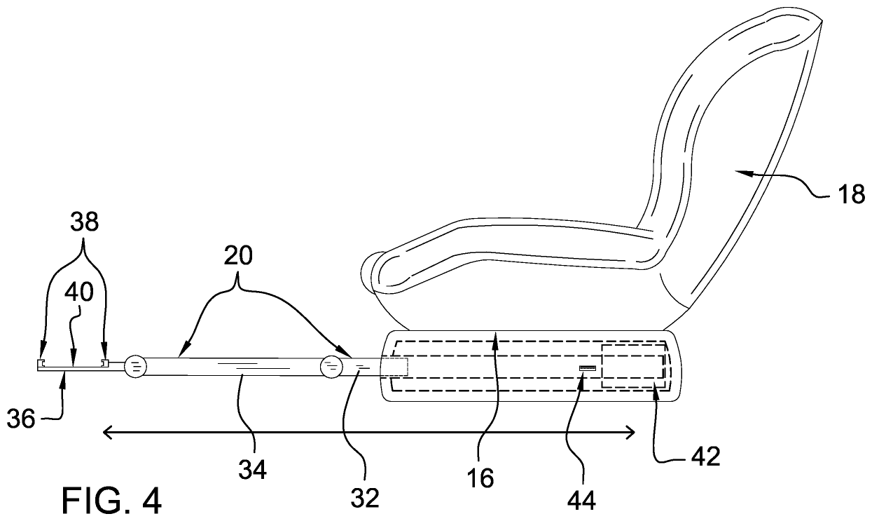

The articulating arm 20 may comprise a first segment 32 and a second segment 34. The first segment 32 is slidably attached to the housing 12 and is slidable from a first position within the interior space 14, as shown in FIG. 3, to an extended position, as shown in FIG. 4, wherein the first segment 32 protrudes substantially perpendicularly from the forward facet 24. The second segment 34 is hingedly attached to the first segment 32 distal from the housing 12 so that the second segment 34 is selectively hingable relative to the first segment 32. The present invention anticipates alternative configurations of the articulating arm 20, such as, but not limited to, gooseneck arms, extensible arms, and the like.

The fastener 28 man comprise an upright 36 and a pair of crosspieces 38, or other fastening means, such as, but not limited to, clamps, suction cups, hook and loop fasteners, and the like. The upright 36 is hingedly attached to the articulating arm 20. Each crosspiece 38 is attached to and extends bidirectionally from the upright 36 so that the pair of crosspieces 38 defines a gap 40. At least one of the crosspieces 38 is slidably attached to and selectively fixedly attachable to the upright 36 so that the gap 40 is selectively sizeable. The at least one of the crosspieces 38 is configured to be slid relative to the upright 36 to selectively engage an electronic device 30, such as a tablet computer, a cellphone, or the like, which is positioned in the gap 40 so that the electronic device 30 is removably attached to the articulating arm 20.

The present invention also anticipates a battery 42, which is positioned in the interior space 14, and a port 44, which is attached to the housing 12 and which is operationally engaged to the battery 42. The electronic device 30, or other device, can be powered from or recharged by the battery 42 by connecting it to the battery 42 via the port 44.

Another embodiment of the disclosure includes a system 46 comprising a child carseat 18, an electronic device 30, and child carseat attachable mounting device 10. Furthermore, this system 46 may comprise a pair of headphones 48, which is communicatively engaged to the electronic device 30, and a smartphone 50, upon which programming code 54 is positioned enabling a user to utilize the smartphone 50 for selecting content for viewing on the electronic device 30. The pair of headphones 48 is configured to broadcast audio to ears of the child who is harnessed to the child carseat 18.

In use, the housing 12 is selectively mounted to the bottom 16 of the child carseat 18. The child carseat 18 then is attached to the seat of the vehicle. The articulating arm is extended through the slot 22 and is adjusted so that the terminus 26 of the articulating arm 20 is positioned in front of a child who is harnessed to the child carseat 18. The fastener 28 is attached to an electronic device 30 so that its display 52 is positioned to be viewed by the child.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A child carseat attachable mounting device comprising:
a housing defining an interior space, the housing being configured to be selectively mountable to a bottom of a child carseat, such that the housing is removably attached to the child carseat and positioned between the child carseat and a seat of a vehicle upon fastening of the child carseat to the seat;
an articulating arm slidably attached to the housing and being selectively extensible through a slot positioned in a forward facet of the housing, such that a terminus of the articulating arm is selectively positionable in front of a child harnessed to the child carseat; and
a fastener hingedly attached to the terminus of the articulating arm and being configured for selectively attaching to an electronic device, such that a display of the electronic device is positioned for viewing by the child.

2. The child carseat attachable mounting device of claim 1, wherein the housing is integral to the child carseat.

3. The child carseat attachable mounting device of claim 1, wherein the articulating arm comprises:
a first segment slidably attached to the housing, such that the first segment is slidable from a first position within the interior space to an extended position, wherein the first segment protrudes substantially perpendicularly from the forward facet; and
a second segment hingedly attached to the first segment distal from the housing, such that the second segment is selectively hingable relative to the first segment.

4. The child carseat attachable mounting device of claim 1, wherein the fastener comprises:
an upright hingedly attached to the articulating arm; and
a pair of crosspieces, each crosspiece being attached to and extending bidirectionally from the upright, such that the pair of crosspieces defines a gap, at least one of the crosspieces being slidably attached to and selectively fixedly attachable to the upright, such that the gap is selectively sizeable, wherein the at least one of the crosspieces is configured for sliding relative to the upright for selectively engaging an electronic device positioned in the gap, such that the electronic device is removably attached to the articulating arm.

5. A child carseat attachable mounting device comprising:
a housing defining an interior space, the housing being configured to be selectively mountable to a bottom of a child carseat, such that the housing is removably attached to the child carseat and positioned between the child carseat and a seat of a vehicle upon fastening of the child carseat to the seat;
an articulating arm slidably attached to the housing and being selectively extensible through a slot positioned in a forward facet of the housing, such that a terminus of the articulating arm is selectively positionable in front of a child harnessed to the child carseat, the articulating arm comprising:
a first segment slidably attached to the housing, such that the first segment is slidable from a first position within the interior space to an extended position, wherein the first segment protrudes substantially perpendicularly from the forward facet, and
a second segment hingedly attached to the first segment distal from the housing, such that the second segment is selectively hingable relative to the first segment; and
a fastener hingedly attached to the terminus of the articulating arm and being configured for selectively attaching to an electronic device, such that a display of the electronic device is positioned for viewing by the child, the fastener comprising:
an upright hingedly attached to the articulating arm, and
a pair of crosspieces, each crosspiece being attached to and extending bidirectionally from the upright, such that the pair of crosspieces defines a gap, at least one of the crosspieces being slidably attached to and selectively fixedly attachable to the upright, such that the gap is selectively sizeable, wherein the at least one of the crosspieces is configured for sliding relative to the upright for selectively engaging an electronic device positioned in the gap, such that the electronic device is removably attached to the articulating arm.

6. The child carseat attachable mounting device of claim 5, wherein the housing is integral to the child carseat.

7. A child carseat attachable mounting system comprising:
a child carseat;
a housing defining an interior space, the housing being mounted to a bottom of the child carseat, such that the housing is positioned between the child carseat and a seat of a vehicle upon fastening of the child carseat to the seat;
an articulating arm slidably attached to the housing and being selectively extensible through a slot positioned in a forward facet of the housing, such that a terminus of the articulating arm is selectively positionable in front of a child harnessed to the child carseat;
a fastener hingedly attached to the terminus of the articulating arm; and
an electronic device attached to the fastener, such that a display of the electronic device is positioned for viewing by the child.

8. The child carseat attachable mounting system of claim 7, wherein the articulating arm comprises:
a first segment slidably attached to the housing, such that the first segment is slidable from a first position within the interior space to an extended position, wherein the first segment protrudes substantially perpendicularly from the forward facet; and
a second segment hingedly attached to the first segment distal from the housing, such that the second segment is selectively hingable relative to the first segment.

9. The child carseat attachable mounting system of claim 7, wherein the fastener comprises:
an upright hingedly attached to the articulating arm; and
a pair of crosspieces, each crosspiece being attached to and extending bidirectionally from the upright, such that the pair of crosspieces defines a gap, at least one of the crosspieces being slidably attached to and selectively fixedly attachable to the upright, such that the gap is selectively sizeable, wherein the at least one of the crosspieces is configured for sliding relative to the upright for selectively engaging an electronic device positioned in the gap, such that the electronic device is removably attached to the articulating arm.

10. The child carseat attachable mounting system of claim 7, further including a pair of headphones communicatively engaged to the electronic device, wherein the pair of headphones is configured for broadcasting audio to ears of the child harnessed to the child carseat.

11. The child carseat attachable mounting system of claim 7, further including:
a smartphone; and
programming code positioned on the smartphone enabling a user for utilizing the smartphone for selecting content for viewing on the electronic device.
